(19) United States
(12) Patent Application Publication
(10) Pub. No.: US 2025/0365076 A1
(43) Pub. Date: Nov. 27, 2025

(54) OPTICAL TRANSMITTER, OPTICAL RECEIVER, OPTICAL TRANSMITTING NODE, AND OPTICAL INTERCONNECTION SYSTEM

(71) Applicant: Omattrix Ltd., Co., Santa Clara, CA (US)

(72) Inventors: Lung Kevin Law, Santa Clara, CA (US); Tom Wu, Santa Clara, CA (US)

(73) Assignee: Omattrix Ltd., Co., Santa Clara, CA (US)

(21) Appl. No.: 19/296,513

(22) Filed: Aug. 11, 2025

(51) Int. Cl. H04B 10/516; H04B 10/69

(52) U.S. Cl. CPC H04B 10/5161; H04B 10/6972

(57) ABSTRACT

The embodiments of the present disclosure relate to an optical transmitter, an optical transmitting node, and an optical interconnection system. The optical transmitter comprises: a light source, for outputting an optical carrier; and an electro-optical modulation structure, comprising a first modulator and a second modulator, wherein the first modulator and the second modulator are configured to acquire a sideband signal for transmitting control data and an in-band signal for transmitting traffic data respectively, and modulate the optical carrier to load the sideband signal and the in-band signal respectively, thereby outputting a first optical signal and a second optical signal.

### TECHNICAL FIELD

The present disclosure relates to the technical field of optical communication and interconnection, and more specifically, to an optical transmitter, an optical receiver, an optical transmitting node, and an optical interconnection system.

### BACKGROUND

In existing electrical interconnection schemes (e.g., electrical interconnection schemes compliant with the PCIe protocol), the transmission of sideband signals is achieved through dedicated signal lines. These sideband signals are mainly used for key functions such as transmission control, management, synchronization, and testing, so as to ensure the normal operation and coordination of devices (e.g., PCIe devices). In these schemes, the transmission of sideband signals relies on electrical signal lines and is carried out under specific protocols and clock control, to ensure signal integrity and reliability. However, with the continuous increase in data transmission rates and the increasing complexity of devices, these existing electrical interconnection schemes gradually reveal some significant defects.

Firstly, existing electrical interconnection schemes require separate signal lines prepared for sideband signals, which increases the complexity and cost of wiring. In high-speed transmission scenarios, these electrical signal lines often need to meet strict electromagnetic compatibility and signal integrity requirements, which further increases the difficulty of design and manufacturing. Secondly, the bandwidth of electrical signal lines is limited, making them difficult to meet the demands of future high-speed communication. Furthermore, as device sizes continue to shrink, the physical limitations of electrical signal lines also make it difficult to further increase wiring density.

### SUMMARY

The embodiments of the present disclosure provide an optical transmitter, an optical receiver, an optical transmitting node, and an optical interconnection system, which utilize optical interconnection techniques (e.g., utilizing optical fibers) to transmit signals, thus capable of transmitting control data (sideband signals) and traffic data (in-band signals), and meeting the requirements of modern communication protocols (e.g., the PCIe protocol). In addition, the optical interconnection scheme according to the embodiments of the present disclosure can effectively transmit sideband signals while avoiding the addition of extra electrical or optical signal lines, which is beneficial for reducing the packaging complexity and line costs of the system.

According to one aspect of the present disclosure, an optical transmitter is provided, comprising: a light source, for outputting an optical carrier; and an electro-optic modulation structure comprising a first modulator and a second modulator, wherein the first modulator is configured to acquire a sideband signal for transmitting control data and modulate the optical carrier to load the sideband signal, thereby outputting a first optical signal (via a modulation process), wherein the second modulator is configured to acquire an in-band signal for transmitting traffic data and modulate the optical carrier to load the in-band signal, thereby outputting a second optical signal (via a modulation process), and wherein the first optical signal and the second optical signal are transmitted by the optical transmitter into a transmission optical path.

According to another aspect of the present disclosure, an optical transmitting node is provided, comprising: a first chip, for generating a sideband signal for transmitting control data and an in-band signal for transmitting traffic data; and a second chip, for generating an optical signal to be transmitted based on the sideband signal and the in-band signal, wherein the second chip comprises: an electro-optic modulation structure comprising a first modulator and a second modulator, where the first modulator is configured to acquire the sideband signal and modulate an optical carrier outputted by a light source to load the sideband signal, thereby outputting a first optical signal (via a modulation process), where the second modulator is configured to acquire the in-band signal and modulate the optical carrier to load the in-band signal, thereby outputting a second optical signal (via a modulation process), and where the first optical signal and the second optical signal are transmitted by the optical transmitting node into a transmission optical path.

According to yet another aspect of the present disclosure, an optical interconnection system is provided, comprising: an optical transmitting node as described above; and an optical receiving node, for receiving an optical signal transmitted by the optical transmitting node via a transmission optical path.

### BRIEF DESCRIPTION OF THE DRAWINGS

The above and other features, advantages, and aspects of the embodiments of the present disclosure will become more apparent in conjunction with the accompanying drawings and with reference to the following detailed description. In the accompanying drawings, the same or similar reference numerals denote the same or similar elements, where:

FIG. 1 illustrates a block diagram of an optical transmitter according to an embodiment of the present disclosure;

FIG. 2 illustrates a block diagram of an optical transmitting node according to an embodiment of the present disclosure;

FIG. 3 illustrates a block diagram of an optical interconnection system according to an embodiment of the present disclosure;

FIG. 4 illustrates a block diagram of an optical interconnection system according to another embodiment of the present disclosure;

FIGS. 5 to 15 illustrate structural schematic diagrams of optical interconnection systems according to various embodiments of the present disclosure; and

FIG. 16 illustrates a flowchart of a method executed by an optical transmitter according to an embodiment of the present disclosure.

### DETAILED DESCRIPTION OF THE EMBODIMENTS

The embodiments of the present disclosure will be described in more detail below with reference to the accompanying drawings. Although certain embodiments of the present disclosure are illustrated in the accompanying drawings, it should be appreciated that the present disclosure can be implemented in various forms and should not be construed as being limited to the embodiments set forth herein. Rather, these embodiments are provided for a more thorough and complete understanding of the present disclosure. It should be appreciated that the accompanying drawings and embodiments of the present disclosure are for illustrative purposes only and are not intended to limit the scope of protection of the present disclosure.

In the description of the embodiments of the present disclosure, the term “include” and similar terms thereof should be understood as open-ended inclusion, meaning “including but not limited to”. The term “based on” should be understood as “at least partially based on”. The term “an embodiment” or “this embodiment” should be understood as “at least one embodiment”. The terms “first”, “second”, and “third” are used solely for descriptive purposes and should not be construed as indicating or implying relative importance. In addition, provided that there is no contradiction, those skilled in the art may bond or combine different embodiments or examples, as well as the features of different embodiments or examples described in the specification.

With the development of AI technologies, the training demands from large models such as ChatGPT and DeepSeek impose increasingly high performance requirements on computers and servers, and also on the interconnection speed of various internal components of computers. With the development of the PCIe protocol, the transmission rate required for channels has doubled. When it comes to PCIe 7.0, the bit rate of transmission has reached 128.0 GT/s. Compared to electrical interconnection, optical interconnection has obvious advantages in terms of transmission rate, distance, and power consumption. Therefore, in the PCIe 7.0 generation, optical interconnection schemes have begun to attract attention.

In the current PCIe protocol, both in-band signals and sideband signals are required for transmission. The in-band signals are used for transmitting traffic data, while the sideband signals are used for transmitting control data-related signals. It is also required that before the transmission of traffic data, the sideband signals can directly transmit control signals to assist in establishing communication channels.

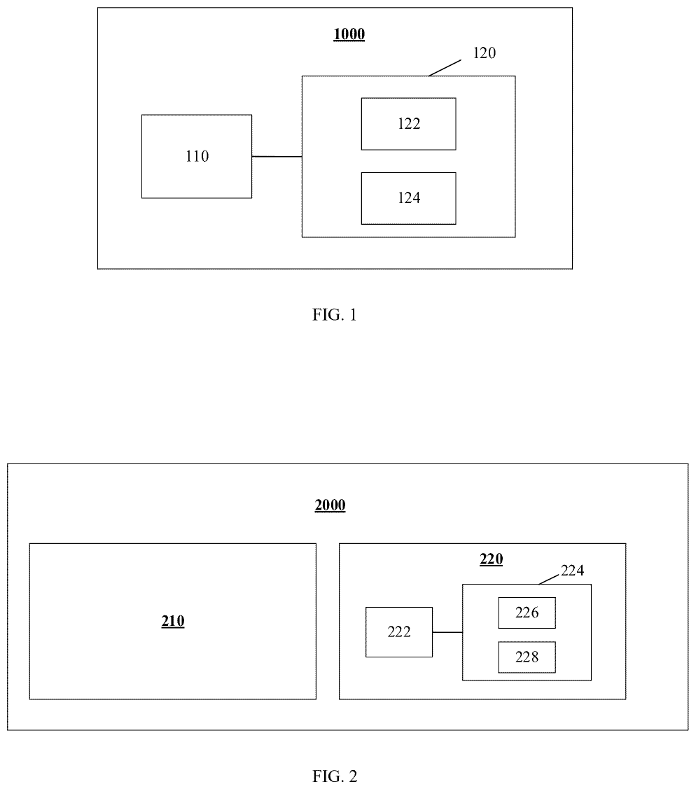

FIG. 1 illustrates a block diagram of an optical transmitter 1000 according to an embodiment of the present disclosure. As illustrated in FIG. 1, the optical transmitter 1000 comprises a light source 110 and an electro-optic modulation structure 120. Wherein, the light source 110 is configured to output an optical carrier, and the electro-optic modulation structure 120 comprises a first modulator 122 and a second modulator 124. Wherein, the first modulator 122 is configured to acquire a sideband signal for transmitting control data and modulate the optical carrier to load the sideband signal, thereby outputting a first optical signal. The second modulator 124 is configured to acquire an in-band signal for transmitting traffic data and modulate the optical carrier to load the in-band signal, thereby outputting a second optical signal. The first optical signal and the second optical signal are transmitted by the transmitter into a transmission optical path.

The light source 110 is configured to output an optical carrier, providing the fundamental optical signal for the subsequent optical modulation process. In one embodiment, the light source 110 may employ various types of lasers, including but not limited to: Distributed Feedback (DFB) lasers and External Cavity Lasers (ECL). Specifically, a Distributed Feedback (DFB) laser achieves single longitudinal mode laser output by providing distributed feedback on a Bragg grating of a semiconductor crystal. Its advantages include small size, low threshold current, high side-mode suppression ratio (SMSR), and low cost, making it suitable for applications requiring high spectral purity. An External Cavity Laser (ECL) achieves wavelength selection and stable output through an external optical cavity (e.g., a volume Bragg grating, tunable filter, etc.). Its primary advantages lie in wavelength tunability, high output power, and narrow linewidth, making it particularly suitable for wavelength division multiplexing (WDM) systems and applications requiring high-precision wavelength control.

The term “electro-optic modulation structure” refers to a structure that modulates the optical carrier generated by a light source to load electrical signals (e.g., sideband signals and in-band signals). In one embodiment, the electro-optic modulation structure 120 comprises a first modulator 122 and a second modulator 124, which are respectively configured to process sideband signals and in-band signals. The first modulator 122 is configured to acquire a sideband signal, and modulate the optical carrier to load the sideband signal, thereby outputting (via the modulation process) a first optical signal. The rate of the sideband signal is typically low (e.g., 10M-100 Mbit/s), so the first modulator 122 can be a low-speed modulator. In one embodiment, the type of the first modulator 122 is selected from either a Mach-Zehnder Modulator (MZM) or an Electro-Absorption Modulator (EAM). The second modulator 124 is configured to acquire an in-band signal, and modulate the optical carrier to load the in-band signal, thereby outputting (via the modulation process) a second optical signal. The rate of the in-band signal is typically high (e.g., 10 Gbit/s or above), so the second modulator 124 can be a high-speed modulator. In one embodiment, the type of the second modulator 124 is selected from any one of a Mach-Zehnder Modulator (MZM), an Electro-Absorption Modulator (EAM), and a Micro-Ring Modulator (MRM).

In one or more embodiments, the Mach-Zehnder Modulator (MZM) utilizes the electro-optic effect to alter the phase and intensity of light, making it suitable for application scenarios requiring high linearity and stability. The Electro-Absorption Modulator (EAM) utilizes an electric field to alter the absorption coefficient of a material, making it suitable for application scenarios requiring fast response and high linearity. The Micro-Ring Modulator (MRM), based on the spectral transmission characteristics of a micro-ring resonator, is suitable for high-integration application scenarios.

In one embodiment, both the sideband signal and the in-band signal comply with the PCIe protocol, and the modulation rate of the first modulator 122 is lower than that of the second modulator 124. That is, the first modulator 122 processes the sideband signal with a lower rate, while the second modulator 124 processes the in-band signal with a higher rate. This design meets the different requirements of the PCIe protocol for signal transmission.

The Micro-Ring Modulator (MRM) typically requires calibration before operation, rendering it unsuitable for the transmission of sideband signals under the PCIe protocol. Specifically, the Micro-Ring Modulator (MRM) modulates based on the characteristic that the transmission spectrum of the micro-ring resonator varies with voltage, where the operating state thereof is sensitive to factors such as bias voltage and temperature. To ensure modulation performance and signal quality, calibration is required before operation. The calibration process includes steps such as setting the bias voltage and compensating for temperature. However, sideband signals under the PCIe protocol are typically used for transmission control, management, synchronization, testing, and other functions. These data or signals need to be transmitted before the transmission of traffic data to establish communication channels and initialize devices. The rate of the sideband signal is typically low (e.g., 10M-100 Mbit/s), which does not require a high modulation rate from the modulator, but demands high stability and reliability of the signals. Since the calibration process of the Micro-Ring Modulator (MRM) requires a certain amount of time, stable transmission of sideband signals cannot be achieved until calibration is complete. This will delay the establishment of communication channels and affect the initialization speed of the system. In contrast, the Mach-Zehnder Modulator (MZM) and Electro-Absorption Modulator (EAM) are more suitable for the modulation and transmission of sideband signals. These two types of modulators can ensure stable transmission of low-speed sideband signals without requiring complex calibration, ensuring rapid initialization and reliable operation of the communication system.

In one embodiment, the first optical signal output by the first modulator 122 loading the sideband signal has a first polarization state (e.g., the horizontal or vertical direction of a linear polarization state), while the second optical signal output by the second modulator 124 loading the in-band signal has a second polarization state that is orthogonal to the first polarization state (e.g., the vertical or horizontal direction of a linear polarization state). Although not illustrated in FIG. 1, the optical transmitter 1000 may further comprise a polarization beam combiner for combining the first optical signal and the second optical signal into a single beam for transmission via a single transmission optical path to achieve polarization division multiplexing. In this embodiment, the polarization beam combiner is configured to combine two optical signals with different polarization states into a single transmission optical path. In this way, on the one hand, by multiplexing two signals onto a single transmission optical path, the number of transmission optical paths required is reduced. That is, through polarization division multiplexing technology, the optical transmitter 1000 can transmit sideband and in-band signals without the addition of extra transmission optical paths, thereby improving system integration and transmission efficiency, while also reducing link costs.

In one embodiment, the light source 110 is configured to output an optical carrier with a first wavelength. The first modulator 122 modulates the optical carrier to load a sideband signal, thereby outputting a first optical signal with the first wavelength. The second modulator 124 modulates the optical carrier to load an in-band signal, thereby outputting a second optical signal with one or more wavelengths different from the first wavelength. Although not illustrated in FIG. 1, the optical transmitter 1000 may further comprise a wavelength division multiplexer for combining the first optical signal and the second optical signal into a single beam, so as to achieve wavelength division multiplexing through transmission via a single transmission optical path. The wavelength division multiplexer, by multiplexing optical signals with different wavelengths onto the same transmission optical path, significantly increases transmission capacity and fully utilizes the bandwidth resources of the optical fibers, thereby avoiding waste of optical fiber resources.

In one embodiment, the first optical signal has a first mode, and the second optical signal has one or more modes different from the first mode. Although not illustrated in FIG. 1, the optical transmitter 1000 may further comprise a mode division multiplexer for combining the first optical signal and the second optical signal into a single beam for transmission via a single transmission optical path to achieve mode division multiplexing. The first optical signal has a first mode, such as the fundamental mode (LP01 mode) propagating in a multimode fiber. The second optical signal has one or more modes different from the first mode, such as a higher-order mode (e.g., LP11 mode). The mode division multiplexer is configured to combine optical signals of different modes into a same transmission optical path. Thus, by means of the mode division multiplexing technology, the optical transmitter 1000 can transmit sideband and in-band signals without the addition of extra transmission optical paths, thereby enhancing system integration and transmission efficiency. This technology is particularly suitable for multimode fiber systems, as it effectively leverages the mode diversity of multimode fibers to increase transmission capacity.

In the context of the present application, the term “transmission optical path” denotes the path configured to transmit modulated optical signals from an optical transmitter to an optical receiver. In one embodiment, the transmission optical path comprises a single transmission optical path (e.g., a single optical fiber). In another embodiment, the transmission optical path comprises a first transmission optical path for transmitting the first optical signal and a second transmission optical path for transmitting the second optical signal. This design reduces the beam splitting and combining structures on the transmitting and receiving chips, simplifies chip design, and reduces signal crosstalk.

In one embodiment, the first optical signal (carrying the sideband signal) can be transmitted before the second optical signal (carrying the in-band signal). This arrangement of transmission sequence ensures that the control and management signals have been established and the communication link has been initialized before the transmission of traffic data, thus preparing for the subsequent transmission of traffic data.

FIG. 2 illustrates a block diagram of an optical transmitting node 2000 according to an embodiment of the present disclosure. As illustrated in FIG. 2, the optical transmitting node 2000 comprises a first chip 210 and a second chip 220. Wherein, the first chip 210 is configured to generate a sideband signal for transmitting control data and an in-band signal for transmitting traffic data, while the second chip 220 is configured to generate an optical signal to be transmitted based on the sideband signal and the in-band signal.

In the embodiment depicted in FIG. 2, the second chip 220 comprises a light source 222 for outputting an optical carrier and an electro-optic modulation structure 224. In FIG. 2, the electro-optic modulation structure 224 comprises a first modulator 226 and a second modulator 228. Wherein, the first modulator 226 is configured to acquire the sideband signal and modulate the optical carrier to load the sideband signal, thereby outputting a first optical signal. The second modulator 228 is configured to acquire the in-band signal and modulate the optical carrier to load the in-band signal, thereby outputting a second optical signal. And, the first optical signal and the second optical signal are transmitted by the optical transmitting node 2000 into a transmission optical path.

In the aforementioned embodiment, both the light source 222 and the electro-optic modulation structure 224 are integrated on the second chip 220. In other embodiments, the light source 222 can be configured outside the second chip 220 or partially configured on the second chip 220. For example, the light source 222 can be completely configured outside the second chip 220. This configuration allows the light source 222 to function as a standalone module, thus facilitating replacement and upgrading, while also facilitating dedicated optimization and calibration of the light source. For another example, some parts of the light source, such as the drive circuit or control circuit, can be integrated with the electro-optic modulation structure 224 on the same chip (e.g., the second chip 220), while the light-emitting part of the light source can remain standalone or only partially integrated.

In one embodiment, the sideband signal and the in-band signal comply with the PCIe protocol, ensuring standardization and compatibility of signal transmission. Specifically, the sideband signal is used for transmission control, management, synchronization, testing and other functions, while the in-band signal is used for transmitting traffic data. In one embodiment, the first chip 210 is a digital chip responsible for generating sideband and in-band signals. For example, this digital chip is responsible for handling all digital signals and converts them into a format suitable for optical transmission. In one embodiment, the second chip 220 is an optical chip comprising a light source 222 and an electro-optic modulation structure 224, for converting electrical signals into optical signals. For example, this optical chip utilizes its internal modulator to modulate the optical carrier, thus achieving optical transmission of signals.

In one or more embodiments, the first chip 210 and the second chip 220 may employ various integration approaches. In one embodiment, the first chip 210 and the second chip 220 are integrated into a same chip. By integrating the first chip (e.g., a digital chip) and the second chip (e.g., an optical chip) into a same chip, the physical size of the system can be significantly reduced and the integration level can be improved. In addition, since the first chip 210 and the second chip 220 are on the same chip, the signal transmission path is shorter, thereby reducing latency. In another embodiment, the first chip 210 and the second chip 220 employ a co-packaging form. In yet another embodiment, the first chip 210 and the second chip 220 are packaged on a same substrate. Compared to monolithic integration, co-packaging or substrate packaging has lower technical thresholds and costs, making them more attainable.

Although not illustrated in FIG. 2, in one embodiment, the optical transmitting node 2000 may further comprise a driver chip for amplifying the in-band signal received from the first chip 210 and providing the amplified in-band signal to the second chip 220. This ensures that the in-band signal has sufficient strength before entering the second chip 220 (e.g., an optical chip), thereby improving modulation efficiency and signal quality.

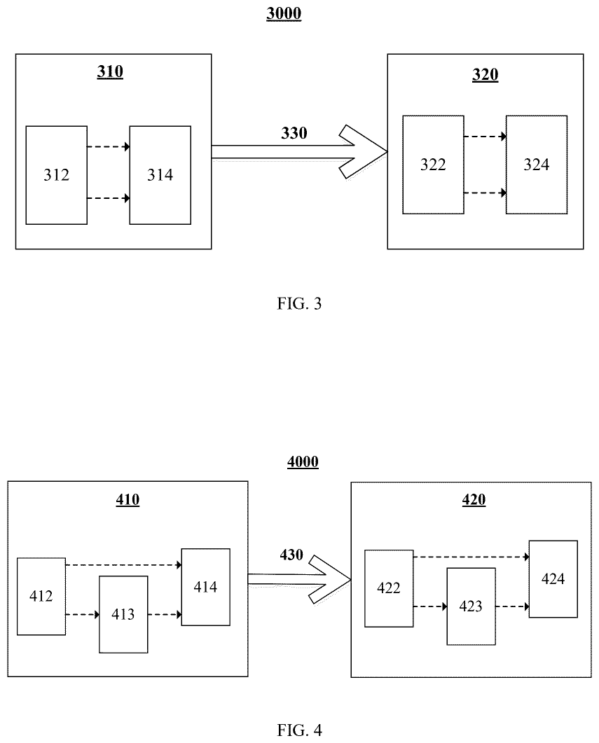

FIG. 3 illustrates a block diagram of an optical interconnection system 3000 according to an embodiment of the present disclosure. As illustrated in FIG. 3, the optical interconnection system 3000 comprises an optical transmitting node 310 and an optical receiving node 320. In FIG. 3, the optical transmitting node 310 comprises a first chip 312 and a second chip 314. Wherein, the first chip 312 is configured to generate a sideband signal for transmitting control data and an in-band signal for transmitting traffic data, while the second chip 314 is configured to generate an optical signal to be transmitted based on the sideband signal and the in-band signal, and transmit the optical signal to the optical receiving node 320 via a transmission optical path 330.

With continued reference to FIG. 3, the optical receiving node 320 comprises a third chip 322 and a fourth chip 324. Wherein, the third chip 322 is configured to generate, based on the received optical signal, a sideband signal for transmitting control data and an in-band signal for transmitting traffic data. And, the fourth chip 324 is configured to receive the sideband signal and the in-band signal from the third chip for digital processing.

In one embodiment, although not illustrated in FIG. 3, the third chip 322 comprises: an optic-electro modulation structure and a signal processing unit. Wherein, the optic-electro modulation structure comprises a first detector for converting the optical signal into a first electrical signal, and one or more detectors, different from the first detector, for converting the optical signal into a second electrical signal. The signal processing unit is coupled to the optic-electro modulation structure, and is configured to process the first electrical signal to extract a sideband signal for transmitting control data, and/or process the second electrical signal to extract an in-band signal for transmitting traffic data.

In the aforementioned embodiment, the optic-electro modulation structure comprises a first detector and one or more other detectors. These detectors function to convert received optical signals into electrical signals. Specifically, the first detector is responsible for converting the optical signal carrying a sideband signal into a first electrical signal. Unlike the first detector, the other detectors are responsible for converting the optical signal carrying an in-band signal into a second electrical signal. In this way, the signal processing unit is tightly coupled with the optic-electro modulation structure, ensuring that the third chip 322 can efficiently extract the required sideband and in-band signals from the optical signals, thereby guaranteeing the accuracy and reliability of data transmission.

The signal processing unit is responsible for processing the electrical signal received from the optic-electro modulation structure to extract the sideband signal and in-band signal. In one or more embodiments, the signal processing unit comprises: a Transimpedance Amplifier (TIA), for amplifying the second electrical signal; and/or a capacitor for performing high-pass filtering on the second electrical signal. The Transimpedance Amplifier (TIA) is configured to amplify the second electrical signal, increase the amplitude of the signal, and ensure that the strength of the signal meets the requirements of subsequent processing. The capacitor is configured to perform high-pass filtering on the second electrical signal, filter out low-frequency noise, and ensure the purity of the signal.

In one embodiment, the third chip 322 may further comprise any one of a Polarization Beam Splitter (PBS), a wavelength division demultiplexer, and a mode division demultiplexer. Specifically, the polarization beam splitter is configured to split the optical signal to separate a first optical signal having a first polarization state and a second optical signal having a second polarization state, wherein the first optical signal is provided to the first detector, and the second optical signal is provided to a second detector different from the first detector. The wavelength division demultiplexer is configured to split the optical signals to separate a first optical signal having a first wavelength and a second optical signal having one or more wavelengths different from the first wavelength, wherein the first optical signal is provided to the first detector, and the second optical signal is provided to one or more detectors different from the first detector. The mode division demultiplexer is configured to split the optical signal to separate a first optical signal having a first mode and a second optical signal having one or more modes different from the first mode, wherein the first optical signal is provided to the first detector, and the second optical signal is provided to one or more detectors different from the first detector.

In the aforementioned embodiment, the polarization beam splitter is configured to split optical signals, separating optical signals with different polarization states. Specifically, the polarization beam splitter decomposes an input optical signal into optical signals of two orthogonal polarization states, such as the horizontal and vertical directions of the linear polarization state. In an optical interconnection system, the polarization beam splitter can separate optical signals of different polarization states carrying sideband signals and in-band signals, and provide them to detectors of different channels for processing. The wavelength division demultiplexer is configured to split optical signals, separating optical signals with different wavelengths. Specifically, the wavelength division demultiplexer decomposes, based on the wavelength differences of optical signals with different wavelengths, a composite optical signal into a plurality of single-wavelength optical signals. In an optical interconnection system, the wavelength division demultiplexer can separate optical signals with different wavelengths carrying sideband signals and in-band signals, and provide them to detectors of different channels for processing. The mode division demultiplexer is configured to split optical signals, separating optical signals with different modes. Specifically, the mode division demultiplexer decomposes, based on the propagation mode differences of optical signals with different modes, a composite optical signal into a plurality of optical signals with different modes. In an optical interconnection system, the mode division demultiplexer can separate optical signals with different modes carrying sideband signals and in-band signals, and provide them to detectors of different channels for processing. By utilizing the polarization beam splitter, wavelength division demultiplexer, or mode division demultiplexer, the third chip 322 can effectively split a composite optical signal into a plurality of independent optical signals, each carrying an independent data stream. This demultiplexing technology enhances the transmission capacity and flexibility of the optical interconnection system, ensuring efficient and reliable data transmission.

In one embodiment, the third chip 322 is an optical chip, and the fourth chip 324 is a digital chip. The third chip 322 and the fourth chip 324 may employ various integration approaches. In one embodiment, the third chip 322 and the fourth chip 324 are integrated into a same chip. Integrating the third chip (e.g., an optical chip) and the fourth chip (e.g., a digital chip) into a same chip significantly reduces the physical size of the system, thus improving integration level and enhancing the performance of signal transmission. In another embodiment, the third chip 322 and the fourth chip 324 employ a co-packaging form. In yet another embodiment, the third chip 322 and the fourth chip 324 are packaged on a same substrate. Compared to monolithic integration, co-packaging or substrate packaging have lower technical thresholds and costs, making them more attainable.

FIG. 4 illustrates a block diagram of an optical interconnection system 4000 according to another embodiment of the present disclosure. As illustrated in FIG. 4, the optical interconnection system 4000 comprises an optical transmitting node 410 and an optical receiving node 420. In FIG. 4, the optical transmitting node 410 comprises a first chip 412, a first driver chip 413, and a second chip 414. Wherein, the first chip 412 is configured to generate a sideband signal for transmitting control data and an in-band signal for transmitting traffic data. The first driver chip 413 is configured to amplify the in-band signal received from the first chip 412 and provide the amplified in-band signal to the second chip 414. The second chip 414 is configured to generate, based on the sideband signal received from the first chip 412 and the in-band signal amplified by the first driver chip 413, an optical signal to be transmitted, and transmit the optical signal to the optical receiving node 420 via a transmission optical path 430.

With continued reference to FIG. 4, the optical receiving node 420 comprises a third chip 422, a second driver chip 423, and a fourth chip 424. Wherein, the third chip 422 is configured to generate, based on the received optical signal, a sideband signal for transmitting control data and an in-band signal for transmitting traffic data. The second driver chip 423 is configured to amplify the in-band signal received from the third chip 422, and provide the amplified in-band signal to the fourth chip 424. The fourth chip 424 is configured to receive the sideband signal from the third chip 422 and the in-band signal from the second driver chip 423 for digital processing.

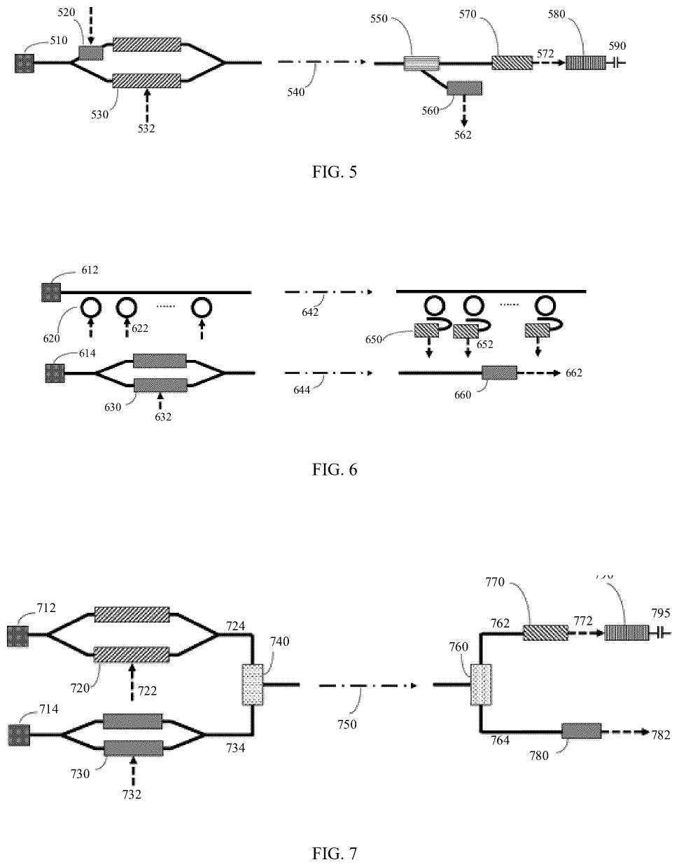

FIGS. 5 to 15 illustrate the structural schematic diagrams of optical interconnection systems according to a plurality of embodiments of the present disclosure.

In one embodiment, the in-band signal and the sideband signal under the PCIe protocol are modulated using a single Mach-Zehnder Modulator (MZM). As illustrated in FIG. 5, at the optical transmitting end, a light source 510 is configured to output an optical carrier. A first modulator 520 and a second modulator 530 jointly form the modulator region of the MZM. The difference between the two lies in that the first modulator 520 is a low-speed modulator configured to load the sideband signal 522, while the second modulator 530 is a high-speed modulator configured to load the in-band signal 532. Additionally, the first modulator 520 is responsible for controlling the operating point of the MZM, ensuring that the entire modulation structure operates in an optimal state. In this way, after the sideband signal and in-band signal are modulated by the low-speed and the high-speed modulators respectively, the output optical signals are combined for transmission via an optical path 540.

At the optical receiving end, an optical splitter 550 separates the optical signal into two parts: one specifically used for extracting the sideband signal, and the other used for extracting the in-band signal. In FIG. 5, a low-speed detector 560 receives the optical signal separated by the optical splitter for demodulating the sideband signal 562. A high-speed detector 570 receives the optical signal to extract the in-band signal 572. A Transimpedance Amplifier (TIA) 580 is configured to amplify the high-speed signal (i.e., the in-band signal 572), and a capacitor 590 acts as a DC-blocking capacitor, performing a high-pass filtering function to filter out the sideband signal with a lower rate, thereby reducing its impact on the in-band signal.

In the aforementioned embodiment, the dual-modulator structure of the MZM enables the simultaneous transmission of sideband and in-band signals, thereby enhancing the utilization efficiency of the optical path. Additionally, the MZM's inherent calibration and operating point control mechanisms ensure that the modulator operates at its optimal operating point, thus enhancing signal quality. This design leverages the characteristics of the MZM effectively, achieving effective transmission of both sideband and in-band signals while reducing system complexity and cost.

In one embodiment, the in-band signal and the sideband signal under the PCIe protocol are modulated using a Micro-Ring Modulator (MRM) and a Mach-Zehnder Modulator (MZM), respectively. As illustrated in FIG. 6, at the optical transmitting end, a first light source 612 is configured to output the first optical carrier, and a second light source 614 is configured to output the second optical carrier. The first modulator 620 is of the type of Micro-Ring Modulator (MRM), while the second modulator 630 is of the type of Mach-Zehnder Modulator (MZM). The first modulator 620 is a high-speed modulator configured to load the in-band signal 622. The second modulator 630 is a low-speed modulator configured to load the sideband signal 632.

In addition, the first modulator 620 modulates the first optical carrier to load the in-band signal 622 and transmits it through the first transmission optical path 642. The second modulator 630 modulates the second optical carrier to load the sideband signal 632 and transmits it through the second transmission optical path 644.

At the optical receiving end, a high-speed detector 650 receives the optical signal via the first transmission optical path 642 and extracts the in-band signal 652 (converted into an electrical signal). A low-speed detector 660 receives the optical signal via the second transmission optical path 660 and extracts the sideband signal 662 (converted into an electrical signal).

In this way, by transmitting in-band and sideband signals through two independent optical paths, mutual interference between signals is avoided. In the aforementioned embodiment, MRM requires calibration before operation to ensure that its operating point and modulation performance are stable. Additionally, MRM is used for in-band signal transmission, leveraging its high-speed modulation capability effectively; MZM is used for sideband signal transmission, utilizing its low-speed modulation stability. This design effectively utilizes the characteristics of MRM and MZM to achieve efficient transmission of in-band and sideband signals, ensuring high performance and reliability of the optical interconnection system.

FIG. 7 illustrates a schematic diagram of transmitting in-band and sideband signals in a same optical path using polarization multiplexing technology according to an embodiment of the present disclosure. As illustrated in FIG. 7, at the optical transmitting end, a first light source 712 is configured to output a first optical carrier, and a second light source 714 is configured to output a second optical carrier. A first modulator 720 is of the type of Mach-Zehnder Modulator (MZM) or Electro-Absorption Modulator (EAM), while a second modulator 730 is of the type of Mach-Zehnder Modulator (MZM) or Electro-Absorption Modulator (EAM). The first modulator 720 is a high-speed modulator configured to load the in-band signal 722, so as to output a first optical signal 724 transmitted in the first polarization state channel. The second modulator 730 is a low-speed modulator configured to load the sideband signal 732, so as to output a second optical signal 734 transmitted in the second polarization state channel.

In the aforementioned embodiment, it is illustrated that the first light source 712 and the second light source 714 output optical carriers separately. In other embodiments, a single light source (e.g., the first light source 712 or the second light source 714) can provide optical carriers for the first modulator 720 and the second modulator 730 through a beam splitter. In this configuration, the optical carriers generated by the single light source are distributed to two modulators by the beam splitter. This design can further reduce the number of system components, simplify system structure, and reduce costs.

With continued reference to FIG. 7, a polarization beam combiner 740 is configured to combine the first optical signal 724 and the second optical signal 734 into a single beam for transmission via a single transmission optical path 750.

At the optical receiving end, a polarization beam splitter 760 is configured to split the optical signal transmitted via the single transmission optical path 750 to separate a third optical signal 762 transmitted in the first polarization state channel and a fourth optical signal 764 transmitted in the second polarization state channel. Wherein, the third optical signal 762 is provided to a first detector 770 (e.g., a high-speed detector) to extract an in-band signal 772, while the fourth optical signal 764 is provided to a second detector 780 (e.g., a low-speed detector) to extract a sideband signal 782. Additionally, a Transimpedance Amplifier (TIA) 790 is configured to amplify the high-speed signal (i.e., the in-band signal 772), and a capacitor 795 acts as a DC-blocking capacitor, performing a high-pass filtering function.

The aforementioned optical interconnection system, by virtue of polarization multiplexing technology, is capable of transmitting sideband and in-band signals without the addition of extra transmission optical paths, thereby enhancing the integration level and transmission efficiency of the system.

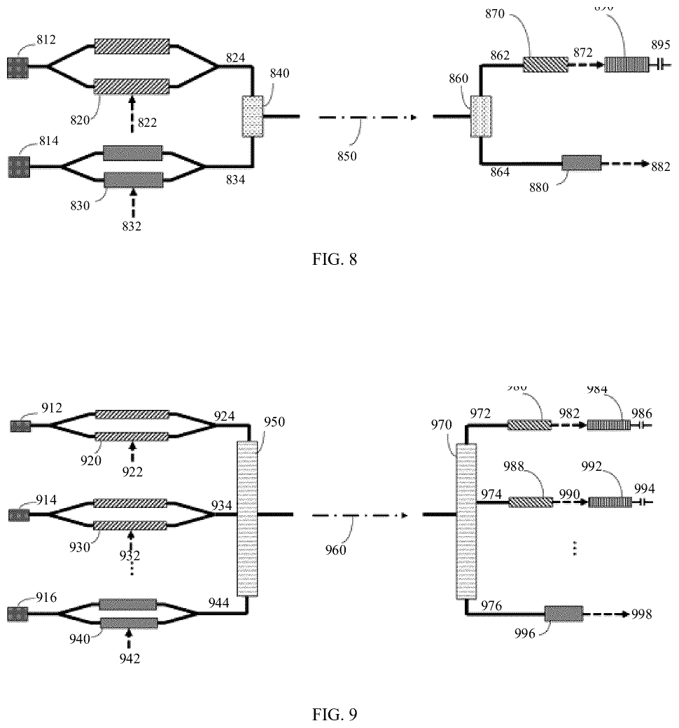

FIG. 8 illustrates a schematic diagram of transmitting in-band and sideband signals in a same optical path using wavelength division multiplexing technology according to an embodiment of the present disclosure. As illustrated in FIG. 8, at the optical transmitting end, a first light source 812 is configured to output a first optical carrier with a first wavelength, and a second light source 814 is configured to output a second optical carrier with a second wavelength. A first modulator 820 is of the type of Mach-Zehnder Modulator (MZM) or Electro-Absorption Modulator (EAM), while the second modulator 830 is of the type of Mach-Zehnder Modulator (MZM) or Electro-Absorption Modulator (EAM). The first modulator 820 is a high-speed modulator configured to modulate the first optical carrier output by the first light source 812 to load an in-band signal 822. Through this modulation process, the in-band signal is loaded onto the first optical carrier, generating a first optical signal 824 with a first wavelength. The second modulator 830 is a low-speed modulator configured to modulate the second optical carrier output by the second light source 814 to load a sideband signal 832. Through this modulation process, the sideband signal is loaded onto the second optical carrier, generating a second optical signal 834 with a second wavelength.

With continued reference to FIG. 8, a wavelength division multiplexer 840 is configured to combine the first optical signal 824 and the second optical signal 834 into a single beam for transmission via a single transmission optical path 850.

At the optical receiving end, a wavelength division demultiplexer 860 is configured to split the optical signal transmitted via the single transmission optical path 850 to separate a third optical signal 862 with a first wavelength and a fourth optical signal 864 with a second wavelength. Wherein, the third optical signal 862 is provided to a first detector 870 (e.g., a high-speed detector) to extract an in-band signal 872, while the fourth optical signal 864 is provided to a second detector 880 (e.g., a low-speed detector) to extract a sideband signal 882. Additionally, a Transimpedance Amplifier (TIA) 890 is configured to amplify the high-speed signal (i.e., the in-band signal 872), and a capacitor 895 acts as a DC-blocking capacitor, performing a high-pass filtering function.

The aforementioned optical interconnection system utilizes a wavelength division multiplexer 840 to combine two optical signals with different wavelengths into a same transmission optical path, thereby increasing transmission capacity and leveraging the bandwidth resources of the optical fibers.

Similar to FIG. 8, FIG. 9 illustrates a schematic diagram of transmitting in-band and sideband signals in a same optical path using wavelength division multiplexing technology according to an embodiment of the present disclosure. However, unlike FIG. 8, the scheme in FIG. 9 employs a plurality of wavelengths to transmit in-band signals. As illustrated in FIG. 9, at the optical transmitting end, a first light source 912 is configured to output a first optical carrier with a first wavelength, a second light source 914 is configured to output a second optical carrier, and a third light source 916 is configured to output a third optical carrier. A first modulator 920 is of the type of Mach-Zehnder Modulator (MZM) or Electro-Absorption Modulator (EAM), the second modulator 930 is of the type of Mach-Zehnder Modulator (MZM) or Electro-Absorption Modulator (EAM), and the third modulator 940 is of the type of Mach-Zehnder Modulator (MZM) or Electro-Absorption Modulator (EAM). The first modulator 920 is a high-speed modulator configured to load a first in-band signal 922, so as to output a first optical signal 924 with a first wavelength through the modulation process. The second modulator 930 is a high-speed modulator configured to load a second in-band signal 932, so as to output a second optical signal 934 with a second wavelength through the modulation process. The third modulator 940 is a low-speed modulator configured to load a sideband signal 942, so as to output a third optical signal 944 with a third wavelength through the modulation process. It should be noted that although only two high-speed modulators are illustrated in FIG. 9, those skilled in the art will appreciate that more modulators can be configured to modulate in-band signals and output optical signals with different wavelengths.

With continued reference to FIG. 9, a wavelength division multiplexer 950 is configured to combine the first optical signal 924, the second optical signal 934, and the third optical signal 944 into a single beam for transmission via a single transmission optical path 960.

At the optical receiving end, a wavelength division demultiplexer 970 is configured to split the optical signal transmitted via the single transmission optical path 960 to separate a fourth optical signal 972 with a first wavelength, a fifth optical signal 974 with a second wavelength, and a sixth optical signal 976 with a third wavelength. Wherein, the fourth optical signal 972 is provided to a first detector 980 (e.g., a high-speed detector) to extract a first in-band signal 982. The fifth optical signal 974 is provided to a second detector 988 (e.g., a high-speed detector) to extract a second in-band signal 990. The sixth optical signal 976 is provided to a third detector 996 (e.g., a low-speed detector) to extract a sideband signal 998. Additionally, a first Transimpedance Amplifier (TIA) 984 and a second Transimpedance Amplifier (TIA) 992 are configured to amplify the first in-band signal 982 and the second in-band signal 990, respectively. And, both the first capacitor 986 and the second capacitor 994 act as DC-blocking capacitors, performing a high-pass filtering function.

The aforementioned optical interconnection system utilizes a Wavelength Division Multiplexer (WDM) 950 to combine a plurality of optical signals with different wavelengths into a same transmission optical path, significantly increasing transmission capacity and leveraging the bandwidth resources of optical fibers, thus avoiding the waste of fiber resources.

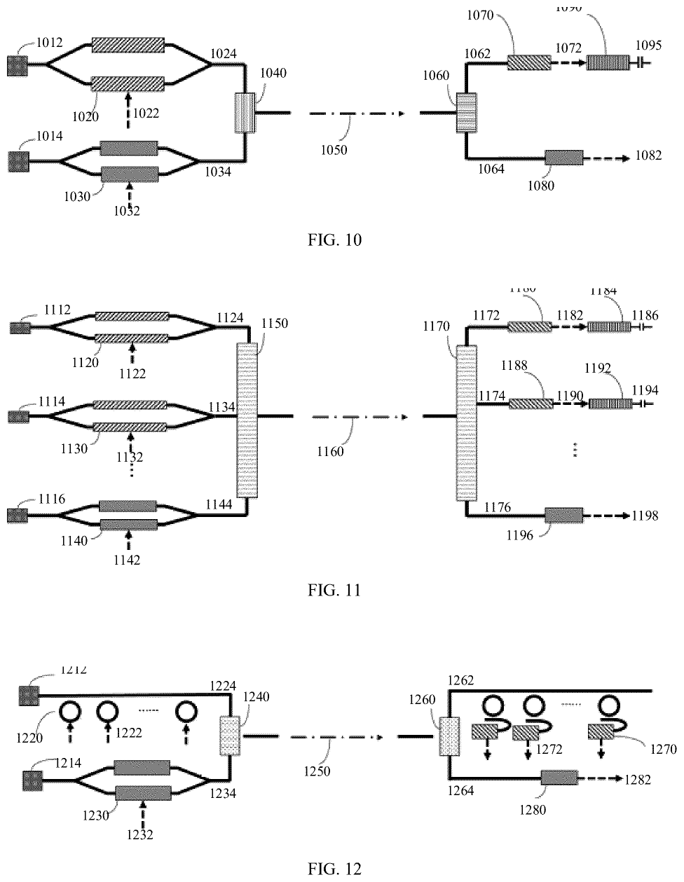

FIG. 10 illustrates a schematic diagram of transmitting in-band and sideband signals in a same optical path using mode multiplexing technology according to an embodiment of the present disclosure. As illustrated in FIG. 10, at the optical transmitting end, a first light source 1012 is configured to output a first optical carrier, and a second light source 1014 is configured to output a second optical carrier. The first modulator 1020 is of the type of Mach-Zehnder Modulator (MZM) or Electro-Absorption Modulator (EAM), while the second modulator 1030 is of the type of Mach-Zehnder Modulator (MZM) or Electro-Absorption Modulator (EAM). The first modulator 1020 is a high-speed modulator configured to load an in-band signal 1022, so as to output a first optical signal 1024 transmitted in a first mode channel. The second modulator 1030 is a low-speed modulator configured to load a sideband signal 1032, so as to output a second optical signal 1034 transmitted in a second mode channel.

In the aforementioned embodiment, it is illustrated that the first light source 1012 and the second light source 1014 output optical carriers separately. In other embodiments, a single light source (e.g., the first light source 1012 or the second light source 1014) can provide optical carriers for the first modulator 1020 and the second modulator 1030 through a beam splitter. In this configuration, the optical carriers generated by the single light source are distributed to two modulators by the beam splitter. This design can further reduce the number of system components (e.g., saving one laser), simplify system structure, and reduce costs.

With continued reference to FIG. 10, a mode multiplexer 1040 is configured to combine the first optical signal 1024 and the second optical signal 1034 into a single beam for transmission via a single transmission optical path 1050.

At the optical receiving end, the mode division demultiplexer 1060 is configured to split the optical signal transmitted via the single transmission optical path 1050 to separate a third optical signal 1062 transmitted in a first mode channel and a fourth optical signal 1064 transmitted in a second mode channel. Wherein, the third optical signal 1062 is provided to a first detector 1070 (e.g., a high-speed detector) to extract an in-band signal 1072, while the fourth optical signal 1064 is provided to a second detector 1080 (e.g., a low-speed detector) to extract a sideband signal 1082. Additionally, a Transimpedance Amplifier (TIA) 1090 is configured to amplify the high-speed signal (i.e., the in-band signal 1072), and a capacitor 1095 acts as a DC-blocking capacitor, performing a high-pass filtering function.

The aforementioned optical interconnection system utilizes a mode division multiplexer 1040 to combine optical signals of two different modes into a same transmission optical path, enabling the transmission of sideband signals and in-band signals without the addition of extra transmission optical paths, thereby enhancing the system's integration level and transmission efficiency.

Similar to FIG. 10, FIG. 11 illustrates a schematic diagram of transmitting in-band and sideband signals in a same optical path using mode division multiplexing technology according to an embodiment of the present disclosure. However, unlike FIG. 10, the scheme in FIG. 11 employs a plurality of modes to transmit in-band signals. As illustrated in FIG. 11, at the optical transmitting end, a first light source 1112 is configured to output a first optical carrier, a second light source 1114 is configured to output a second optical carrier, and a third light source 1116 is configured to output a third optical carrier. A first modulator 1120 is of the type of Mach-Zehnder Modulator (MZM) or Electro-Absorption Modulator (EAM), a second modulator 1130 is of the type of Mach-Zehnder Modulator (MZM) or Electro-Absorption Modulator (EAM), and a third modulator 1140 is of the type of Mach-Zehnder Modulator (MZM) or Electro-Absorption Modulator (EAM). The first modulator 1120 is a high-speed modulator configured to load a first in-band signal 1122 for transmitting a first optical signal 1124 in a first mode channel. The second modulator 1130 is a high-speed modulator configured to load a second in-band signal 1132 for transmitting a second optical signal 1134 in a second mode channel. The third modulator 1140 is a low-speed modulator configured to load a sideband signal 1142 for transmitting a third optical signal 1144 in a third mode channel. It should be noted that although only two high-speed modulators are illustrated in FIG. 11, those skilled in the art will appreciate that more modulators can be configured to modulate in-band signals.

In the aforementioned embodiment, it is illustrated that the first light source 1112 and the second light source 1114 output optical carriers separately. In other embodiments, a single light source (e.g., the first light source 1112 or the second light source 1114) can provide optical carriers for the first modulator 1120 and the second modulator 1130 through a beam splitter. In this configuration, the optical carriers generated by the single light source are distributed to two modulators by the beam splitter. This design can further reduce the number of system components (e.g., saving one laser), simplify system structure, and reduce costs.

With continued reference to FIG. 11, a mode multiplexer 1150 is configured to combine the first optical signal 1124, the second optical signal 1134, and the third optical signal 1144 into a single beam for transmission via a single transmission optical path 1160.

At the optical receiving end, the mode division demultiplexer 1170 is configured to split the optical signal transmitted via the single transmission optical path 1160 to separate a fourth optical signal 1172 with a first mode, a fifth optical signal 1174 with a second mode, and a sixth optical signal 1176 with a third mode (that is, separating signals of different mode channels in the transmission optical path 1160). Wherein, the fourth optical signal 1172 is provided to a first detector 1180 (e.g., a high-speed detector) to extract a first in-band signal 1182, the fifth optical signal 1174 is provided to a second detector 1188 (e.g., a high-speed detector) to extract a second in-band signal 1190, and the sixth optical signal 1176 is provided to a third detector 1196 (e.g., a low-speed detector) to extract a sideband signal 1198. Additionally, a first Transimpedance Amplifier (TIA) 1184 and a second Transimpedance Amplifier (TIA) 1192 are configured to amplify the first in-band signal 1182 and the second in-band signal 1190, respectively. And, both the first capacitor 1186 and the second capacitor 1194 are DC-blocking capacitors, performing a high-pass filtering function.

The aforementioned optical interconnection system utilizes a mode division multiplexer 1150 to combine a plurality of optical signals transmitted in different mode channels into corresponding different modes in a same transmission optical path, enabling the transmission of sideband and in-band signals without the addition of extra transmission optical paths, thereby enhancing the system's integration level and transmission efficiency.

FIG. 12 illustrates a schematic diagram of transmitting in-band and sideband signals under the PCIe protocol in a same optical path using polarization multiplexing technology according to an embodiment of the present disclosure. In FIG. 12, a Micro-Ring Modulator (MRM) and a Mach-Zehnder Modulator (MZM) are respectively configured for modulation. As illustrated in FIG. 12, at the optical transmitting end, a first light source 1212 is configured to output a first optical carrier, and a second light source 1214 is configured to output a second optical carrier. A first modulator 1220 is of the type of Micro-Ring Modulator (MRM), while a second modulator 1230 is of the type of Mach-Zehnder Modulator (MZM). The first modulator 1220 is a high-speed modulator configured to load an in-band signal 1222, so as to output a first optical signal 1224 with a first polarization state through the modulation process. The second modulator 1230 is a low-speed modulator configured to load a sideband signal 1232, so as to output a second optical signal 1234 with a second polarization state through the modulation process.

In the aforementioned embodiment, it is illustrated that the first light source 1212 and the second light source 1214 output optical carriers separately. In other embodiments, a single light source (e.g., the first light source 1212 or the second light source 1214) can provide optical carriers for the first modulator 1220 and the second modulator 1230 through a beam splitter. In this configuration, the optical carriers generated by the single light source are distributed to two modulators by the beam splitter. This design can further reduce the number of system components (e.g., saving one laser), simplify system structure, and reduce costs.

With continued reference to FIG. 12, a polarization beam combiner 1240 is configured to combine the first optical signal 1224 and the second optical signal 1234 into a single beam for transmission via a single transmission optical path 1250.

At the optical receiving end, a polarization beam splitter 1260 is configured to split the optical signal transmitted via the single transmission optical path 1250 to separate a third optical signal 1262 with a first polarization state and a fourth optical signal 1264 with a second polarization state. Wherein, the third optical signal 1262 is provided to a first detector 1270 (e.g., a high-speed detector) to extract an in-band signal 1272, while the fourth optical signal 1264 is provided to a second detector 1280 (e.g., a low-speed detector) to extract a sideband signal 1282.

The aforementioned optical interconnection system, by utilizing polarization multiplexing technology, enables the transmission of sideband and in-band signals without the addition of extra transmission optical paths, thereby enhancing the system's integration level and transmission efficiency.

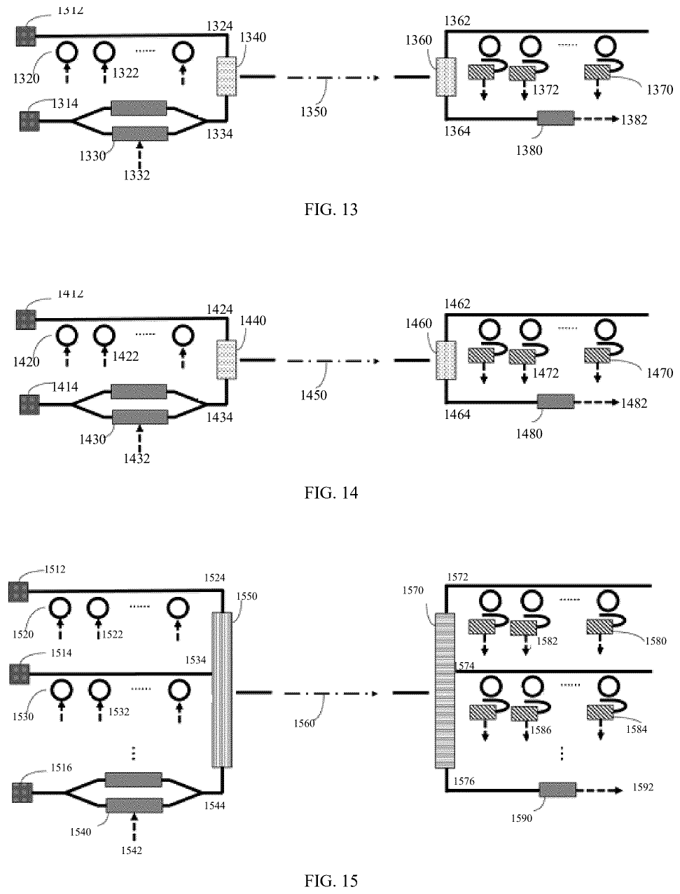

FIG. 13 illustrates a schematic diagram of transmitting in-band and sideband signals under the PCIe protocol in a same optical path using Wavelength Division Multiplexing (WDM) technology according to an embodiment of the present disclosure. In FIG. 13, a Micro-Ring Modulator (MRM) and a Mach-Zehnder Modulator (MZM) are respectively configured for modulation. As shown in FIG. 13, at the optical transmitting end, a first light source 1312 is configured to output a first optical carrier, and a second light source 1314 is configured to output a second optical carrier. A first modulator 1320 is of the type of Micro-Ring Modulator (MRM), while a second modulator 1330 is of the type of Mach-Zehnder Modulator (MZM). The first modulator 1320 is a high-speed modulator configured to load an in-band signal 1322, so as to output a first optical signal 1324 with a plurality of wavelengths. The second modulator 1330 is a low-speed modulator configured to load a sideband signal 1332, so as to output a second optical signal 1334 with a second wavelength different from that of the first optical signal 1324.

With continued reference to FIG. 13, a wavelength division multiplexer 1340 is configured to combine the first optical signal 1324 and the second optical signal 1334 into a single beam for transmission via a single transmission optical path 1350.

At the optical receiving end, a wavelength division demultiplexer 1360 is configured to split the optical signal transmitted via the single transmission optical path 1350 to separate a third optical signal 1362 with a plurality of wavelengths and a fourth optical signal 1364 with a second wavelength. Wherein, the third optical signal 1362 is provided to a first detector 1370 (e.g., a high-speed detector) to extract an in-band signal 1372, and the fourth optical signal 1364 is provided to a second detector 1380 (e.g., a low-speed detector) to extract a sideband signal 1382.

The aforementioned optical interconnection system utilizes a wavelength division multiplexer 1340 to combine a plurality of optical signals with different wavelengths into a same transmission optical path, thereby increasing transmission capacity and leveraging the bandwidth resources of optical fibers.

FIG. 14 illustrates a schematic diagram of transmitting in-band and sideband signals under the PCIe protocol in a same optical path using Mode Division Multiplexing (MDM) technology according to an embodiment of the present disclosure. In FIG. 14, a Micro-Ring Modulator (MRM) and a Mach-Zehnder Modulator (MZM) are respectively employed for modulation. As illustrated in FIG. 14, at the optical transmitting end, a first light source 1412 is configured to output a first optical carrier, and a second light source 1414 is configured to output a second optical carrier. The first modulator 1420 is of the type of Micro-Ring Modulator (MRM), while the second modulator 1430 is of the type of Mach-Zehnder Modulator (MZM). The first modulator 1420 is a high-speed modulator configured to load an in-band signal 1422 for transmitting a first optical signal 1424 in a first mode channel. The second modulator 1430 is a low-speed modulator configured to load a sideband signal 1432 for transmitting a second optical signal 1434 in a second mode channel.

In the aforementioned embodiment, it is illustrated that the first light source 1412 and the second light source 1414 output optical carriers separately. In other embodiments, a single light source (e.g., the first light source 1412 or the second light source 1414) can provide optical carriers for the first modulator 1420 and the second modulator 1430 through a beam splitter. In this configuration, the optical carriers generated by the single light source are distributed to two modulators by the beam splitter. This design can further reduce the number of system components (e.g., saving one laser), simplify system structure, and reduce costs. With continued reference to FIG. 14, a mode division multiplexer 1440 is configured to combine the first optical signal 1424 and the second optical signal 1434 into a single beam for transmission via a single transmission optical path 1450.

At the optical receiving end, a mode division demultiplexer 1460 is configured to split the optical signal transmitted via the single transmission optical path 1450 to separate a third optical signal 1462 with a first mode and a fourth optical signal 1464 with a second mode. Wherein, the third optical signal 1462 is provided to a first detector 1470 (e.g., a high-speed detector) to extract an in-band signal 1472, while the fourth optical signal 1464 is provided to a second detector 1480 (e.g., a low-speed detector) to extract a sideband signal 1482.

The aforementioned optical interconnection system utilizes a mode division multiplexer 1440 to combine two optical signals of different modes into a same transmission optical path, enabling the transmission of sideband and in-band signals without the addition of extra transmission optical paths, thereby enhancing the system's integration level and transmission efficiency.

Similar to FIG. 14, FIG. 15 illustrates a schematic diagram of transmitting in-band and sideband signals under the PCIe protocol in a same optical path using mode division multiplexing technology according to an embodiment of the present disclosure. In FIG. 15, a plurality of Micro-Ring Modulators (MRMs) and Mach-Zehnder Modulators (MZMs) are employed for modulation. As illustrated in FIG. 15, at the optical transmitting end, a first light source 1512 is configured to output a first optical carrier, a second light source 1514 is configured to output a second optical carrier, and a third light source 1516 is configured to output a third optical carrier. A first modulator 1520 is of the type of Micro-Ring Modulator (MRM), a second modulator 1530 is of the type of Micro-Ring Modulator (MRM), and a third modulator 1540 is of the type of Mach-Zehnder Modulator (MZM). The first modulator 1520 is a high-speed modulator configured to load a first in-band signal 1522 for transmitting a first optical signal 1524 in a first mode channel. The second modulator 1530 is a high-speed modulator configured to load a second in-band signal 1532 for transmitting a second optical signal 1534 in a second mode channel. The third modulator 1540 is a low-speed modulator configured to load a sideband signal 1542 for transmitting a third optical signal 1544 in a third mode channel.

In the aforementioned embodiment, it is illustrated that the first light source 1512, the second light source 1514, and the third light source 1516 output optical carriers, respectively. In other embodiments, a single light source (e.g., the first light source 1512, the second light source 1514, or the third light source 1516) can provide optical carriers to the first modulator 1520, the second modulator 1530, and the third modulator 1540 through a beam splitter. In this configuration, the optical carriers generated by the single light source are distributed to three modulators by the beam splitter. This design can further reduce the number of system components, simplify system structure, and reduce costs.

With continued reference to FIG. 15, a mode division multiplexer 1550 is configured to combine the first optical signal 1524, the second optical signal 1534, and the third optical signal 1544 into a single beam for transmission via a single transmission optical path 1560.

At the optical receiving end, a mode demultiplexer 1570 is configured to split the optical signal transmitted via the single transmission optical path 1560 to separate a fourth optical signal 1572 with a first mode, a fifth optical signal 1574 with a second mode, and a sixth optical signal 1576 with a third mode. Wherein, the fourth optical signal 1572 is provided to a first detector 1580 (e.g., a high-speed detector) to extract ac first in-band signal 1582. The fifth optical signal 1574 is provided to a second detector 1584 (e.g., a high-speed detector) to extract a second in-band signal 1586. The sixth optical signal 1576 is provided to a third detector 1590 (e.g., a low-speed detector) to extract a sideband signal 1592.

The aforementioned optical interconnection system utilizes a mode division multiplexer 1550 to combine a plurality of optical signals of different modes into a same transmission optical path, enabling the transmission of sideband and in-band signals without the addition of extra transmission optical paths, thereby enhancing the system's integration level and transmission efficiency.

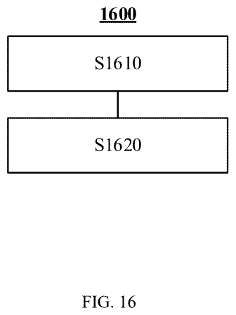

Referring to FIG. 16, one aspect of the present disclosure also relates to a method 1600 executed by an optical transmitter. The optical transmitter comprises an electro-optic modulation structure, which comprises a first modulator and a second modulator. The method 1600 comprises: in step S1610, the first modulator is utilized to acquire a sideband signal for transmitting control data and modulate an optical carrier to load the sideband signal, thereby outputting a first optical signal; in step S1620, the second modulator is utilized to acquire an in-band signal for transmitting traffic data and modulate the optical carrier to load the in-band signal, thereby outputting a second optical signal. Wherein, the first optical signal and the second optical signal are transmitted by the optical transmitter into a transmission optical path.

In one embodiment, the type of the first modulator is selected from any one of a Mach-Zehnder Modulator (MZM) and an Electro-Absorption Modulator (EAM), and the type of the second modulator is selected from any one of a Mach-Zehnder Modulator (MZM), an Electro-Absorption Modulator (EAM), and a Micro-Ring Modulator (MRM). In one embodiment, the sideband signal and the in-band signal comply with the PCIe protocol, and the modulation rate of the first modulator is lower than that of the second modulator.

In one embodiment, the first optical signal has a first polarization state, and the second optical signal has a second polarization state. Additionally, the method 1600 further comprises: utilizing a polarization beam combiner to combine the first optical signal and the second optical signal into a single beam for transmission via a single transmission optical path, thereby achieving polarization multiplexing.

In one embodiment, the first optical signal has a first wavelength, and the second optical signal has one or more wavelengths different from the first wavelength. Additionally, the method 1600 further comprises: utilizing a wavelength division multiplexer to combine the first optical signal and the second optical signal into a single beam for transmission via a single transmission optical path, thereby achieving wavelength division multiplexing.

In one embodiment, the first optical signal is transmitted in a first mode channel, and the second optical signal is transmitted in another mode channel different from the first mode channel. Additionally, the method 1600 further comprises: utilizing a mode division multiplexer to combine the first optical signal and the second optical signal into a single beam for transmission via a single transmission optical path, thereby achieving mode division multiplexing.

In one embodiment, the transmission optical path comprises a first transmission optical path for transmitting the first optical signal and a second transmission optical path for transmitting the second optical signal. In one embodiment, the first optical signal is transmitted before the second optical signal.

The various methods or processes described above can be executed by a CPU. For instance, in some embodiments, the methods can be implemented as computer software programs tangibly embodied in a machine-readable medium, such as a storage unit. In some embodiments, part or all of the computer programs can be loaded and/or installed onto a computer device via an ROM and/or a communication unit. When the computer programs are loaded into an RAM and executed by the CPU, one or more steps or actions of the methods or processes described above can be executed.

In some embodiments, the methods and processes described above can be implemented as computer program products. Computer program products may include computer-readable storage media on which computer-readable program instructions for executing various aspects of the present disclosure are uploaded.

Computer-readable storage media may be tangible devices capable of retaining and storing instructions for use by an instruction execution device. Examples of computer-readable storage media include, but are not limited to, electrical storage devices, magnetic storage devices, optical storage devices, electromagnetic storage devices, semiconductor storage devices, or any suitable combination of the foregoing. More specific examples of computer-readable storage media (not an exhaustive list) include: portable computer disks, hard disks, Random Access Memory (RAM), Read-Only Memory (ROM), Erasable Programmable Read-Only Memory (EPROM or flash memory), Static Random Access Memory (SRAM), Compact Disc-Read Only Memory (CD-ROM), Digital Versatile Discs (DVD), memory sticks, floppy disks, mechanically encoded devices such as punch cards or raised structures in grooves on which instructions are stored, and any suitable combination of the foregoing.

The computer-readable program instructions described herein can be downloaded from a computer-readable storage medium to various computing/processing devices, or downloaded to external computers or external storage devices through networks such as the Internet, Local Area Networks (LANs), Wide Area Networks (WANs), and/or wireless networks. Networks may include copper transmission cables, fiber optic transmission, wireless transmission, routers, firewalls, switches, gateway computers, and/or edge servers. The network adapter card or network interface in each computing/processing device receives computer-readable program instructions from the network and forwards them for storage in the computer-readable storage medium of each computing/processing device.

The computer program instructions for executing the operations of the present disclosure may be assembly instructions, Instruction Set Architecture (ISA) instructions, machine instructions, machine-dependent instructions, microcode, firmware instructions, status setting data, or source code or object code written in any combination of one or more programming languages, where the programming languages include object-oriented programming languages, as well as conventional procedural programming languages. The computer-readable program instructions may be executed entirely on a user's computer, partially on a user's computer, as a standalone software package, partially on a user's computer and partially on a remote computer, or entirely on a remote computer or server. In scenarios involving a remote computer, the remote computer may be connected to the user's computer through any kind of network, including a Local Area Network (LAN) or a Wide Area Network (WAN), or may be connected to an external computer (e.g., through an Internet service provider for connection over the Internet). In some embodiments, an electronic circuit, such as a programmable logic circuit, Field Programmable Gate Array (FPGA), or Programmable Logic Array (PLA), may be customized by utilizing the status information of the computer-readable program instructions, and the electronic circuit may execute the computer-readable program instructions to implement various aspects of the present disclosure.

These computer-readable program instructions can be provided to the processing units of a general-purpose computer, a dedicated computer, or other programmable data processing devices, thereby producing a machine that, when these instructions are executed by the processing units of a computer or other programmable data processing devices, results in an apparatus that implements the functions/actions specified in one or more blocks of the block diagrams. These computer-readable program instructions can also be stored in a computer-readable storage medium, where these instructions enable computers, programmable data processing devices, and/or other devices to operate in a specific manner. Thus, the computer-readable medium storing the instructions comprises an article of manufacture that includes instructions for implementing various aspects of the functions/actions specified in one or more blocks of the block diagrams.

The computer-readable program instructions can also be loaded onto a computer, other programmable data processing devices, or other apparatuses, enabling a series of operational steps to be executed on the computer, other programmable data processing devices, or other apparatuses, to produce a computer-implemented process. This allows the instructions executed on the computer, other programmable data processing devices, or other apparatuses to fulfill the functions/actions specified in one or more blocks of the block diagrams.

The embodiments of the present disclosure have been described above. The above description is exemplary but not exhaustive, and is not limited to the various embodiments disclosed. Without departing from the scope and spirit of the various embodiments described, many modifications and variations will be apparent to those skilled in the art. The selection of terminology herein is to best explain the principles and practical applications of the embodiments, or technical improvements to the technology on the market, or to enable others skilled in the art to understand the embodiments disclosed herein.

Below are some exemplary implementations of the present disclosure.

Example 1. An optical transmitter, comprising:
a light source, for outputting an optical carrier; and
an electro-optic modulation structure, comprising a first modulator and a second modulator,
wherein, the first modulator is configured to acquire a sideband signal for transmitting control data and modulate the optical carrier to load the sideband signal, thereby outputting a first optical signal,
wherein, the second modulator is configured to acquire an in-band signal for transmitting traffic data and modulate the optical carrier to load the in-band signal, thereby outputting a second optical signal, and
wherein, the first optical signal and the second optical signal are transmitted by the optical transmitter into a transmission optical path.

Example 2. The optical transmitter according to Example 1, wherein a type of the first modulator is selected from any one of a Mach-Zehnder Modulator (MZM) and an Electro-Absorption Modulator (EAM), and a type of the second modulator is selected from any one of a Mach-Zehnder Modulator (MZM), an Electro-Absorption Modulator (EAM), and a Micro-Ring modulator (MRM).

Example 3. The optical transmitter according to Example 1, wherein the sideband signal and the in-band signal comply with a PCIe protocol, and a modulation rate of the first modulator is lower than that of the second modulator.

Example 4. The optical transmitter according to Example 1, wherein the first optical signal has a first polarization state, and the second optical signal has a second polarization state, and wherein the optical transmitter further comprises:
a polarization beam combiner, for combining the first optical signal and the second optical signal into a single beam for transmission via a single transmission optical path.

Example 5. The optical transmitter according to Example 1, wherein the first optical signal has a first wavelength, and the second optical signal has one or more wavelengths different from the first wavelength, and wherein the optical transmitter further comprises:

a wavelength division multiplexer, for combining the first optical signal and the second optical signal into a single beam for transmission via a single transmission optical path.

Example 6. The optical transmitter according to Example 1, wherein the first optical signal has a first mode, and the second optical signal has one or more modes different from the first mode, and wherein the optical transmitter further comprises:
a mode division multiplexer, for combining the first optical signal and the second optical signal into a single beam for transmission through a single transmission optical path.

Example 7. The optical transmitter according to Example 1, wherein the transmission optical path comprises a first transmission optical path for transmitting the first optical signal and a second transmission optical path for transmitting the second optical signal.

Example 8. The optical transmitter according to Example 1, wherein the first optical signal is transmitted before the second optical signal.

Example 9. An optical transmitting node, comprising:
a first chip, for generating a sideband signal for transmitting control data and an in-band signal for transmitting traffic data; and
a second chip, for generating an optical signal to be transmitted based on the sideband signal and the in-band signal, wherein the second chip comprises:
a light source, for outputting an optical carrier; and
an electro-optic modulation structure comprising a first modulator and a second modulator,
wherein, the first modulator is configured to acquire the sideband signal and modulate the optical carrier to load the sideband signal, thereby outputting a first optical signal,
wherein, the second modulator is configured to acquire the in-band signal and modulate the optical carrier to load the in-band signal, thereby outputting a second optical signal, and
wherein, the first optical signal and the second optical signal are transmitted by the optical transmitting node into a transmission optical path.

Example 10. The optical transmitting node according to Example 9, wherein the sideband signal and the in-band signal comply with a PCIe protocol, and the first chip is a digital chip while the second chip is an optical chip.

Example 11. The optical transmitting node according to Example 9, wherein the first chip and the second chip are integrated into a same chip.

Example 12. The optical transmitting node according to Example 9, wherein the first chip and the second chip employ a co-packaging form or are packaged on a same substrate.

Example 13. The optical transmitting node according to Example 9, further comprising:
a driver chip, for amplifying an in-band signal received from the first chip, and providing the in-band signal amplified to the second chip.

Example 14. The optical transmitting node according to Example 9, wherein a type of the first modulator is selected from any one of a Mach-Zehnder Modulator (MZM) and an Electro-Absorption Modulator (EAM), and a type of the second modulator is selected from any one of a Mach-Zehnder Modulator (MZM), an Electro-Absorption Modulator (EAM), and a Micro-Ring Modulator (MRM).

Example 15. The optical transmitting node according to Example 9, wherein a modulation rate of the first modulator is lower than that of the second modulator.

Example 16. The optical transmitting node according to Example 9, wherein the first optical signal has a first polarization state, and the second optical signal has a second polarization state, and wherein the second chip further comprises:
a polarization beam combiner, for combining the first optical signal and the second optical signal into a single beam for transmission via a single transmission optical path.

Example 17. The optical transmitting node according to Example 9, wherein the first optical signal has a first wavelength, and the second optical signal has one or more wavelengths different from the first wavelength, and wherein the second chip further comprises:
a wavelength division multiplexer, for combining the first optical signal and the second optical signal into a single beam for transmission via a single transmission optical path.

Example 18. The optical transmitting node according to Example 9, wherein the first optical signal has a first mode, and the second optical signal has one or more modes different from the first mode, and wherein the second chip further comprises:
a mode division multiplexer, for combining the first optical signal and the second optical signal into a single beam for transmission via a single transmission optical path.

Example 19. The optical transmitting node according to Example 9, wherein the transmission optical path comprises a first transmission optical path for transmitting the first optical signal and a second transmission optical path for transmitting the second optical signal.

Example 20. The optical transmitting node according to Example 9, wherein the first optical signal is transmitted before the second optical signal.

Example 21. An optical receiver, comprising:
an optic-electro modulation structure, comprising a first detector for converting the optical signal into a first electrical signal and one or more detectors, different from the first detector, for converting the optical signal into a second electrical signal; and
a signal processing unit, coupled to the optic-electro modulation structure, for processing the first electrical signal to extract a sideband signal for transmitting control data, and/or for processing the second electrical signal to extract an in-band signal for transmitting traffic data.

Example 22. The optical receiver according to Example 21, wherein the signal processing unit comprises:
a transimpedance amplifier, for amplifying the second electrical signal; and/or
a capacitor, for performing high-pass filtering on the second electrical signal.

Example 23. The optical receiver according to Example 21, wherein one or more detectors different from the first detector comprise a second detector, and the optical receiver further comprises:
a polarization beam splitter, for splitting the optical signal to separate a first optical signal having a first polarization state and a second optical signal having a second polarization state, wherein the first optical signal is provided to the first detector, and the second optical signal is provided to the second detector; or
a wavelength division demultiplexer, for splitting the optical signal to separate a first optical signal having a first wavelength and a second optical signal having one or more wavelengths different from the first wavelength, wherein the first optical signal is provided to the first detector, and the second optical signal is provided to one or more detectors different from the first detector; or
a mode division demultiplexer, for splitting the optical signal to separate a first optical signal having a first mode and a second optical signal having one or more modes different from the first mode, wherein the first optical signal is provided to the first detector, and the second optical signal is provided to one or more detectors different from the first detector.

Example 24. The optical receiver according to Example 21, wherein the sideband signal and the in-band signal comply with a PCIe protocol, and a detection rate of the first detector is lower than that of one or more detectors different from the first detector.

Example 25. An optical receiving node, comprising:
a third chip, comprising an optical receiver according to any one of Examples 21 to 24, configured to generate, based on the optical signal received, a sideband signal for transmitting control data and an in-band signal for transmitting traffic data; and
a fourth chip, for receiving the sideband signal and the in-band signal from the third chip for digital processing.

Example 26. The optical receiving node according to Example 25, wherein the third chip is an optical chip, and the fourth chip is a digital chip.

Example 27. The optical receiving node according to Example 25, wherein the third chip and the fourth chip are integrated into a same chip.

Example 28. The optical receiving node according to Example 25, wherein the third chip and the fourth chip employs a co-packaging form or are packaged on a same substrate.

Example 29. The optical receiving node according to Example 25, further comprising:
a driver chip, for amplifying the in-band signal received from the third chip, and providing the in-band signal amplified to the fourth chip.

Example 30. An optical interconnection system, comprising:
an optical transmitting node according to any one of Examples 9 to 20; and
an optical receiving node according to any one of Examples 25 to 29.

Example 31. A server, wherein the server comprises an optical interconnection system according to Example 30.

Example 32. A computer, wherein the computer comprises an optical interconnection system according to Example 30.

Example 33. A method executed by an optical transmitter, wherein the optical transmitter comprises an electro-optic modulation structure comprising a first modulator and a second modulator, the method comprising:
utilizing the first modulator to acquire a sideband signal for transmitting control data and modulate an optical carrier to load the sideband signal, thereby outputting a first optical signal,
utilizing the second modulator to acquire an in-band signal for transmitting traffic data and modulate the optical carrier to load the in-band signal, thereby outputting a second optical signal, and
wherein, the first optical signal and the second optical signal are transmitted by an optical transmitter into a transmission optical path.

Example 34. The method according to Example 33, wherein a type of the first modulator is selected from any one of a Mach-Zehnder Modulator (MZM) and an Electro-Absorption Modulator (EAM), and a type of the second modulator is selected from any one of a Mach-Zehnder Modulator (MZM), an Electro-Absorption Modulator (EAM), and a Micro-Ring Modulator (MRM).

Example 35. The method according to Example 33, wherein the sideband signal and the in-band signal comply with a PCIe protocol, and a modulation rate of the first modulator is lower than that of the second modulator.

Example 36. The method according to Example 33, wherein the first optical signal has a first polarization state, and the second optical signal has a second polarization state, and wherein the method further comprises:
utilizing a polarization beam combiner to combine the first optical signal and the second optical signal into a single beam for transmission via a single transmission optical path.

Example 37. The method according to Example 33, wherein the first optical signal has a first wavelength, and the second optical signal has one or more wavelengths different from the first wavelength, and wherein the method further comprises:
utilizing a wavelength division multiplexer to combine the first optical signal and the second optical signal into a single beam for transmission via a single transmission optical path.

Example 38. The method according to Example 33, wherein the first optical signal has a first mode, and the second optical signal has one or more modes different from the first mode, and wherein the method further comprises:
utilizing a mode division multiplexer to combine the first optical signal and the second optical signal into a single beam for transmission via a single transmission optical path.

Example 39. The method according to Example 33, wherein the transmission optical path comprises a first transmission optical path for transmitting the first optical signal and a second transmission optical path for transmitting the second optical signal.

Example 40. The method according to Example 33, wherein the first optical signal is transmitted before the second optical signal.

Although the present disclosure has been described using languages specific to structural features and/or methodological logical actions, it should be appreciated that the subject matter defined in the appended claims is not necessarily limited to the specific features or actions described above. Rather, the specific features and actions described above are merely exemplary forms for implementing the claims.

What is claimed is:

1. An optical transmitter, comprising:
a light source, for outputting an optical carrier; and
an electro-optic modulation structure, comprising a first modulator and a second modulator,
wherein, the first modulator is configured to acquire a sideband signal for transmitting control data and modulate the optical carrier to load the sideband signal, thereby outputting a first optical signal,
wherein, the second modulator is configured to acquire an in-band signal for transmitting traffic data and modulate the optical carrier to load the in-band signal, thereby outputting a second optical signal, and
wherein, the first optical signal and the second optical signal are transmitted by the optical transmitter into a transmission optical path.

2. The optical transmitter according to claim 1, wherein a type of the first modulator is selected from any one of a Mach-Zehnder Modulator (MZM) and an Electro-Absorption Modulator (EAM), and a type of the second modulator is selected from any one of a Mach-Zehnder Modulator (MZM), an Electro-Absorption Modulator (EAM), and a Micro-Ring Modulator (MRM).

3. The optical transmitter according to claim 1, wherein the sideband signal and the in-band signal comply with a PCIe protocol, and a modulation rate of the first modulator is lower than that of the second modulator.

4. The optical transmitter according to claim 1, wherein the first optical signal has a first polarization state, and the second optical signal has a second polarization state, and wherein the optical transmitter further comprises:
a polarization beam combiner, for combining the first optical signal and the second optical signal into a single beam for transmission via a single transmission optical path.

5. The optical transmitter according to claim 1, wherein the first optical signal has a first wavelength, and the second optical signal has one or more wavelengths different from the first wavelength, and wherein the optical transmitter further comprises:
a wavelength division multiplexer, for combining the first optical signal and the second optical signal into a single beam for transmission via a single transmission optical path.

6. The optical transmitter according to claim 1, wherein the first optical signal has a first mode, and the second optical signal has one or more modes different from the first mode, and wherein the optical transmitter further comprises:
a mode division multiplexer, for combining the first optical signal and the second optical signal into a single beam for transmission through a single transmission optical path.

7. An optical transmitting node, comprising:
a first chip, for generating a sideband signal for transmitting control data and an in-band signal for transmitting traffic data; and
a second chip, for generating an optical signal to be transmitted based on the sideband signal and the in-band signal, wherein the second chip comprises:
an electro-optic modulation structure comprising a first modulator and a second modulator,
wherein, the first modulator is configured to acquire the sideband signal and modulate an optical carrier outputted by a light source to load the sideband signal, thereby outputting a first optical signal,
wherein, the second modulator is configured to acquire the in-band signal and modulate the optical carrier to load the in-band signal, thereby outputting a second optical signal, and
wherein, the first optical signal and the second optical signal are transmitted by the optical transmitting node into a transmission optical path.

8. The optical transmitting node according to claim 7, wherein the sideband signal and the in-band signal comply with a PCIe protocol, and the first chip is a digital chip while the second chip is an optical chip.

9. The optical transmitting node according to claim 7, wherein the first chip and the second chip are integrated into a same chip, or the first chip and the second chip employ a co-packaging form or are packaged on a same substrate.

10. The optical transmitting node according to claim 7, further comprising:
a driver chip, for amplifying an in-band signal received from the first chip, and providing the in-band signal amplified to the second chip.

11. An optical interconnection system, comprising:
an optical transmitting node according to claim 7; and
an optical receiving node, for receiving an optical signal transmitted by the optical transmitting node via a transmission optical path.

12. The optical interconnection system according to claim 11, wherein the optical receiving node comprises:
a third chip, for generating a sideband signal for transmitting control data and an in-band signal for transmitting traffic data based on the optical signal received, wherein the third chip comprises:
an optic-electro modulation structure, the optic-electro modulation structure comprising a first detector for converting the optical signal into a first electrical signal and one or more detectors, different from the first detector, for converting the optical signal into a second electrical signal; and
a signal processing unit, coupled to the optic-electro modulation structure, for processing the first electrical signal to extract the sideband signal, and/or for processing the second electrical signal to extract the in-band signal.

13. The optical interconnection system according to claim 12, wherein the signal processing unit comprises:
a transimpedance amplifier, for amplifying the second electrical signal; and/or
a capacitor, for performing high-pass filtering on the second electrical signal.

14. The optical interconnection system according to claim 12, wherein one or more detectors different from the first detector comprise a second detector, and the third chip further comprises:
a polarization beam splitter, for splitting the optical signal to separate a first optical signal with a first polarization state and a second optical signal with a second polarization state, wherein the first optical signal is provided to the first detector, and the second optical signal is provided to the second detector; or
a wavelength division demultiplexer, for splitting the optical signal to separate a first optical signal with a first wavelength and a second optical signal with one or more wavelengths different from the first wavelength, wherein the first optical signal is provided to the first detector, and the second optical signal is provided to one or more detectors different from the first detector; or
a mode division demultiplexer, for splitting the optical signal to separate a first optical signal having a first mode and a second optical signal having one or more modes different from the first mode, wherein the first optical signal is provided to the first detector, and the second optical signal is provided to one or more detectors different from the first detector.

15. The optical interconnection system according to claim 12, wherein a detection rate of the first detector is lower than that of one or more detectors different from the first detector.

16. The optical interconnection system according to claim 12, wherein the third chip is an optical chip, and the optical receiving node further comprises:
a fourth chip, wherein the fourth chip is a digital chip for receiving the sideband signal and the in-band signal from the third chip for digital processing.

17. A method executed by an optical transmitter, wherein the optical transmitter comprises an electro-optic modulation structure comprising a first modulator and a second modulator, the method comprising:
utilizing the first modulator to acquire a sideband signal for transmitting control data and modulate an optical carrier to load the sideband signal, thereby outputting a first optical signal,
utilizing the second modulator to acquire an in-band signal for transmitting traffic data and modulate the optical carrier to load the in-band signal, thereby outputting a second optical signal, and
wherein, the first optical signal and the second optical signal are transmitted by an optical transmitter into a transmission optical path.

18. The method according to claim 17, wherein the first optical signal has a first polarization state, and the second optical signal has a second polarization state, and wherein the method further comprises:
utilizing a polarization beam combiner to combine the first optical signal and the second optical signal into a single beam for transmission via a single transmission optical path.

19. The method according to claim 17, wherein the first optical signal has a first wavelength, and the second optical signal has one or more wavelengths different from the first wavelength, and wherein the method further comprises:
utilizing a wavelength division multiplexer to combine the first optical signal and the second optical signal into a single beam for transmission via a single transmission optical path.

20. The method according to claim 17, wherein the first optical signal has a first mode, and the second optical signal has one or more modes different from the first mode, and wherein the method further comprises:
utilizing a mode division multiplexer to combine the first optical signal and the second optical signal into a single beam for transmission via a single transmission optical path.

21. An optical receiver, comprising:
an optic-electro modulation structure, comprising a first detector for converting an optical signal into a first electrical signal, and one or more other detectors, different from the first detector, for converting the optical signal into a second electrical signal; and
a signal processing unit, coupled to the optic-electro modulation structure, for processing the first electrical signal to extract a sideband signal for transmitting control data, and/or for processing the second electrical signal to extract an in-band signal for transmitting traffic data.
